(19) United States
(12) Patent Application Publication
(10) Pub. No.: US 2024/0235070 A1
(43) Pub. Date: Jul. 11, 2024

(54) Multi-Dimensional, Flux-Excluding, Low-Inductance Electrical Interconnect

(71) Applicant: Helion Energy, Inc., Everett, WA (US)

(72) Inventors: Brian Campbell, Shoreline, WA (US); David Kirtley, Seattle, WA (US); Christopher James Pihl, Woodinville, WA (US)

(73) Assignee: Helion Energy, Inc., Everett, WA (US)

(21) Appl. No.: 18/561,831

(22) PCT Filed: May 19, 2022
(86) PCT No.: PCT/US2022/030005

§ 371 Date: Nov. 17, 2023

Related U.S. Application Data
(60) Provisional application No. 63/190,883, filed on May 20, 2021.

(51) Int. Cl. H01R 9/24; H01R 43/18

(52) U.S. Cl. CPC H01R 9/2491; H01R 43/18

(57) ABSTRACT

An apparatus includes an insert block which in turn includes contact elements to electrically couple to first conductors of a set of cables. The insert block also includes first interconnects, each first interconnect including a passage formed through the volume of the insert block. The apparatus also includes an insulator block coupled to the insert block and including second interconnects aligned to the set of first interconnects. The apparatus further includes a back plate coupled to the insulator block and including a set of third interconnects aligned to the set of first interconnects and the set of second interconnects. During use, the cables are disposable through the first interconnects, the second interconnects, and the third interconnects such that, for each cable, a second conductor of that cable is electrically insulated from the insert block and is electrically coupled to the back plate.

### CROSS REFERENCE TO RELATED APPLICATION(S)

This application claims priority to U.S. Provisional Application No. 63/190,883 titled “CARTRIDGE APPARATUSES FOR ELECTRICAL INTERCONNECTION”, filed May 20, 2021, the entire disclosure of which is incorporated herein by reference.

### BACKGROUND

Certain motors, solenoids, actuators, lights, and other apparatuses require high current or high voltage delivery. In turn, this usually requires the connection of a large number of cables in the proximity of the apparatus, while still desiring compactness of the interconnection. Use of multiple cables is often required or desired in such scenarios (instead of single, large/high capacity cables) for maneuverability, economic reasons, and/or other system design considerations. Close placement of such cables that deliver high currents, high voltages, and rapidly changing currents can increase incidence of heating, changes in local impedance (e.g., increased stray inductance at the interconnection), or problematic electric field topologies.

As an example, in several systems, such as the particle acceleration systems generally disclosed in U.S. Pat. Nos. 9,145,874 and 9,741,457, electrical components such as magnetic coils can be employed for manipulating plasma and/or other materials, and can require high magnetic fields for effectiveness. In turn, this requires high currents to be applied to the electrical components. Traditional connection approaches are often bulky and difficult to integrate, and can also lead to loss of performance by adding parasitic inductance; this is especially harmful for low inductance loads. This, in turn, can lead to larger system costs and/or lower performance since more energy must be stored and delivered to get a desired amount of energy into the load, such as a magnetic coil.

However, shifting to compact system design can result in placement of the coils in close proximity to each other and/or to the electrical component(s), which in turn places significant spatial limitations on circuitry for high current delivery to the electrical components, such as via coaxial cables. Limited current delivery in turn can limit, for example, the magnetic fields that can be generated by (electrical component) magnetic coils.

### SUMMARY

Accordingly, there is an unmet need for cartridge apparatuses, including cartridge apparatuses that are generally capable of consolidating a large number of current-supplying cables to a compact footprint while maintaining the ability to supply high voltage, high current, and/or pulsed electrical currents/voltages with the aforementioned impedance, heating, and/or other undesirable effects.

Aspects disclosed herein are directed to an apparatus for coupling a set of cables to an electrical component. The apparatus includes an insert block defining a first surface and a second surface and a volume therebetween, the insert block being electrically conductive. The insert block includes a set of contact elements disposed on the first surface to electrically couple to a set of first conductors of the set of cables. The insert block also includes a set of first interconnects arranged as an array through the volume of the insert block, each first interconnect including a passage formed through the volume of the insert block. The apparatus also includes an insulator block coupled to the insert block at the second surface and including a set of second interconnects aligned to the set of first interconnects, the insulator block being electrically insulating. The apparatus further includes a back plate coupled to the insulator block and including a set of third interconnects aligned to the set of first interconnects and the set of second interconnects, the back plate being electrically conductive. In this manner, a set of second conductors of the set of cables are disposable through the set of first interconnects, the set of second interconnects, and the set of third interconnects such that the set of second conductors are electrically insulated from the insert block and are electrically coupled to the back plate.

Aspects disclosed herein are further directed to a method of assembling an apparatus for coupling a set of cables to an electrical component. The method includes coupling an insert block to an insulator block, the insert block defining a first surface and a second surface and a volume therebetween such that the insulator block is coupled to the insert block at the second surface. The insulator block is electrically insulating while the insert block is electrically conductive. The insert block includes a set of contact elements disposed on the first surface to electrically couple to a set of first conductors of the set of cables. The insert block also includes a set of first interconnects arranged as an array through the volume of the insert block, each first interconnect including a passage formed through the volume of the insert block. The coupling further includes disposing portions of the insulator block within the insert block such that each second interconnect of a set of second interconnects of the insulator block is at least partially disposed within a broad portion of a corresponding first interconnect of the set of first interconnects. The method further includes coupling a back plate to the insulator block, the back plate being electrically conductive, such that each third interconnect of a set of third interconnects of the back plate is aligned with a corresponding second interconnect of the set of second interconnects of the insulator block. In this manner, during use, a set of second conductors of a the set of cables are disposable through the set of first interconnects, the set of second interconnects, and the set of third interconnects and the set of second conductors of that the set of cables are electrically isolatable from the insert block and are electrically couplable to the back plate.

Aspects disclosed herein are further directed to a method of circulating electrical current to an electrical component via a set of cables coupled to an apparatus. The method includes delivering the electrical current to the set of cables coupled to the apparatus. The apparatus includes an insert block defining a first surface and a second surface and a volume therebetween, the insert block being electrically conductive and electrically coupled to the electrical component. The insert block includes a set of contact elements disposed on the first surface that are electrically coupled to a set of first conductors of the set of cables. The insert block also includes a set of first interconnects arranged as an array through the volume of the insert block, each first interconnect including a passage formed through the volume of the insert block. The apparatus also includes an insulator block coupled to the insert block and including a set of second interconnects to align with the set of first interconnects, the insulator block being electrically insulating. The apparatus further includes a back plate including a set of third interconnects aligned with the set of first interconnects and the set of second interconnects. The set of cables are disposed through the set of first interconnects, the set of second interconnects, and the set of third interconnects such that, for each cable of the set of cables, a second conductor of that cable is electrically insulated from the insert block and is electrically coupled to the back plate, the back plate being electrically conductive. The step of delivering the electrical current further includes the delivering including delivering the electrical current to the electrical component via one of the back plate and the insert block. The method further includes receiving, from the electrical component, a return current via the other of the insert block and the back plate.

Aspects disclosed herein are further directed to an apparatus for coupling a set of cables to an electrical component. The apparatus includes an insert block defining a first surface and a second surface and a volume therebetween, the insert block being electrically conductive. The insert block includes a set of contact elements disposed on the first surface to electrically couple to a set of first conductors of the set of cables. The insert block also includes a set of first interconnects arranged as an array through the volume of the insert block, each first interconnect including a passage formed through the volume of the insert block. The apparatus further includes an insulator block coupled to the insert block at the second surface and including a set of second interconnects aligned to the set of first interconnects, the insulator block being electrically insulating. In this manner, a set of second conductors of the set of cables are disposable through the set of first interconnects and the set of second interconnects such that the set of second conductors are electrically insulated from the insert block.

Aspects disclosed herein are further directed to a kit that includes a set of cables, each cable of the set of cables including a first conductor and a second conductor. The kit further includes an insert block defining a first surface and a second surface and a volume therebetween, the insert block being electrically conductive. The insert block includes a set of contact elements disposed on the first surface to electrically couple to a set of first conductors of the set of cables. The insert block further includes a set of first interconnects arranged as an array through the volume of the insert block, each first interconnect including a passage formed through the volume of the insert block. The kit further includes an insulator block couplable to the insert block at the second surface and including a set of second interconnects that can be aligned to the set of first interconnects, the insulator block being electrically insulating. The kit also includes a back plate couple able to the insulator block and including a set of third interconnects that can be aligned to the set of first interconnects and the set of second interconnects, the back plate being electrically conductive. In this manner, wherein a set of second conductors of the set of cables are disposable through the set of first interconnects, the set of second interconnects, and the set of third interconnects such that the set of second conductors can be electrically insulated from the insert block and can be electrically coupled to the back plate.

### BRIEF DESCRIPTION OF THE DRAWINGS

FIG. 1 shows a portion of a cartridge apparatus suitable for connecting cables carrying current to an inductor or other load.

FIG. 2 is another view of the cartridge apparatus of FIG. 1.

FIG. 3 shows how a coaxial cable is stripped and affixed to additional components prior to insertion into a cartridge apparatus as disclosed herein, such as the cartridge apparatus of FIG. 1.

FIG. 4 shows a set of coaxial cables connected to the cartridge apparatus of FIG. 1.

FIG. 5 illustrates a sectioned view through interconnects of a cartridge apparatus (such as the cartridge apparatus of FIG. 1), and further illustrates a coaxial cable disposed in the interconnects.

FIG. 6 illustrates an example cartridge setup.

FIG. 7 is a flowchart of an example method of assembling a cartridge apparatus.

FIG. 8 is a flowchart of an example method of circulating an electrical current to an electrical component using a cartridge apparatus.

### DETAILED DESCRIPTION

### Cartridge Apparatus

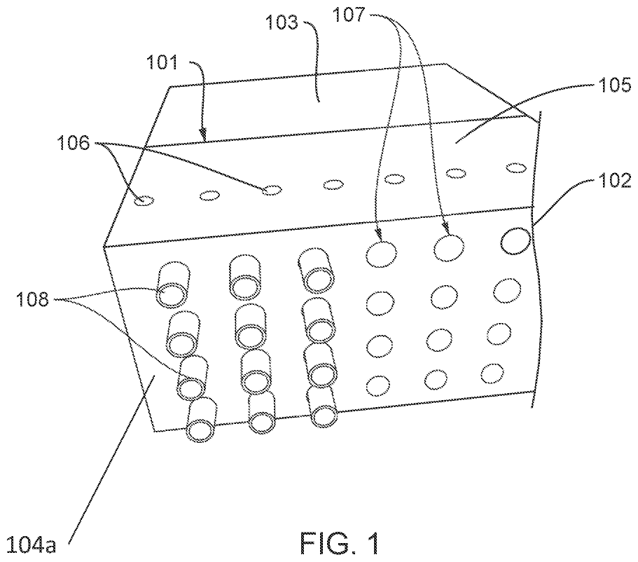

FIGS. 1-6 generally illustrate a cartridge apparatus 101, and various components thereof, suitable for use with any electrical component, apparatus, system, component, etc. requiring high current delivery in a confined space. For example, the cartridge apparatus 101 can find application in systems such as, but not limited to, medical isotope generators, particle accelerators, cyclotrons, RADAR, induction heating systems, pulsed laser sources, electrical transport systems, magnet-forming systems, fusion reactors, and/or the like. In some cases, the electrical component can be or include a magnetic coil.

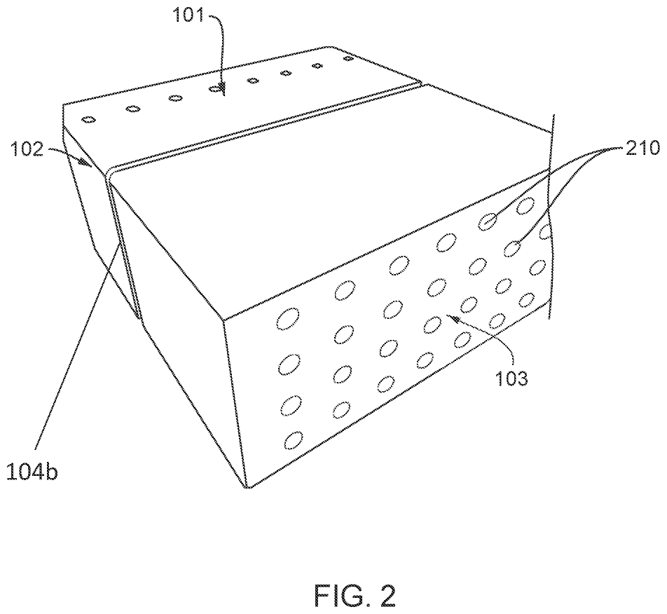

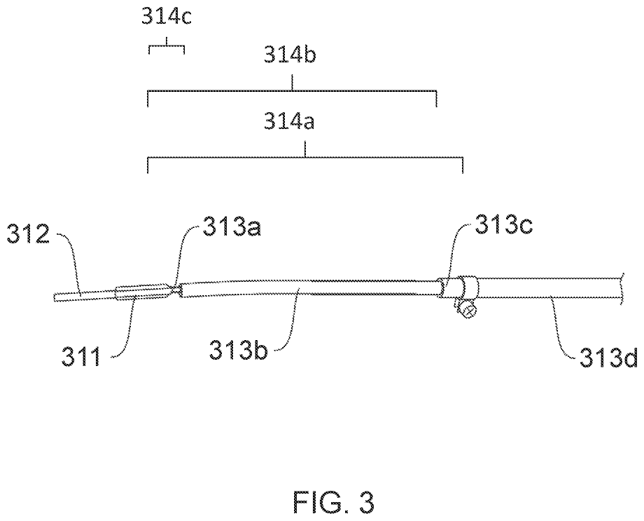

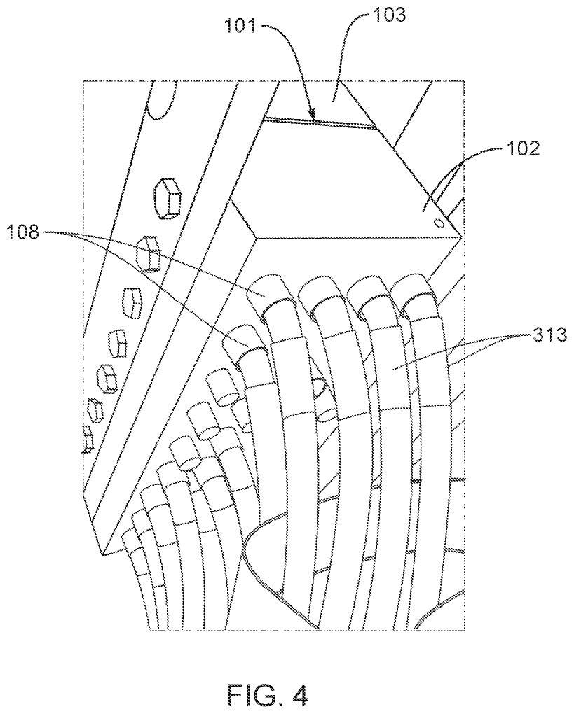

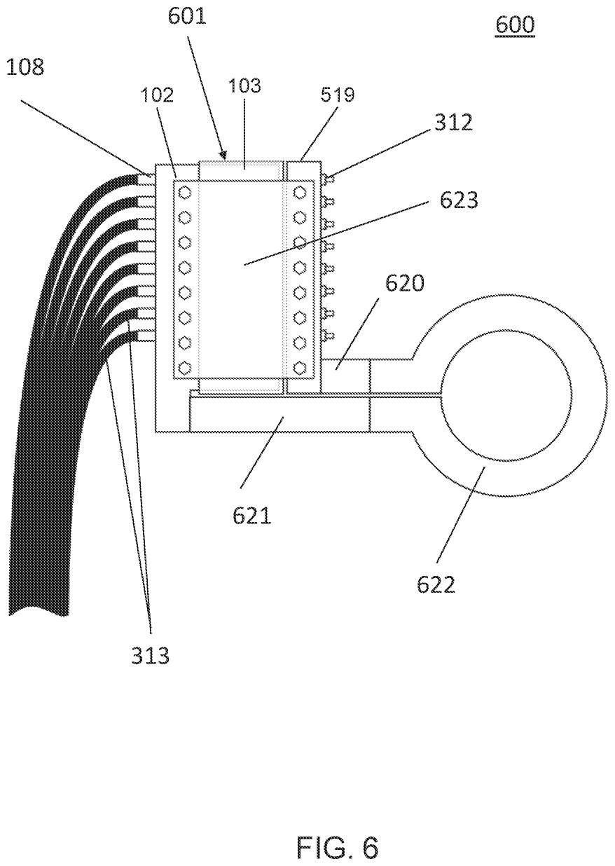

FIGS. 1 and 2 are perspective views of portions of the cartridge apparatus 101 without any cables attached. FIG. 3 is a detailed view of structure and components of a cable insertable into the cartridge apparatus 101, while FIGS. 4-6 shows the cartridge apparatus 101 in use, with coaxial cables (e.g., of FIG. 3) attached for delivery of electrical current/voltage. FIG. 6 illustrates a system/setup 600 that includes a cartridge apparatus 601 with a larger number of cables being attachable than that of the apparatus 101. It is understood that while illustrated and described herein with respect to coaxial cables for simplicity, any other suitable cable design can be employed such as twisted wire pairs, triaxial cables, and/or the like, as explained in greater detail in the next section.

The cartridge apparatus 101 can be adapted and/or useful for use in any setting where a high volumetric density of electrical cables such as, for example, coaxial cables, is required or desirable. Further, the cartridge apparatus 101 can be particularly useful when transmission of high voltages (e.g., up to 10 kV, up to 20 kV, up to 35 kV, up to 50 kV, up to 75 kV, up to 100 kV, including all values and sub-ranges in between), high currents (e.g., up to 1 mega-amp (MA), up to 2 MA, up to 3 MA, up to 4 MA, including all values and sub-ranges in between), high rates of current change (e.g., up to 1.e¹¹ A/s), low reactive impedance, is required or desirable.

The cartridge apparatus 101 includes an insert block 102, an insulator block 103, and a plate 519 (also sometimes referred to as a ‘back plate’, des). The insert block 102 is illustrated as being generally cuboid in shape and can include a first surface 104a, an opposed second surface 104b, and a substrate or body portion 105 therebetween that can be composed of any suitable electrically conductive material such as, but not limited to, aluminum, aluminum alloys, steel, copper alloys, ceramic-metal hybrids, and/or combinations thereof. The body portion 105 can include receptacles 106 configured for mechanical connection of the insert block 102 for supporting the cartridge apparatus 101 such as, for example, by forming a mechanical connection between the insert block 102 and a dielectric plate (e.g., see the side plate 623 in FIG. 6). While illustrated as slots, it is understood that any suitable male (e.g., plug, pin, screw, prong, etc.) or female (e.g., slots, sockets, etc.) connector can be employed on the body portion 105 to facilitate providing mechanical support to the cartridge apparatus 101.

Formed through the body portion 105 are multiple interconnects (sometimes also referred to as “first interconnects”) or passageways 107 for receiving the electrical cables. The interconnects 107 are disposed as an N×M array that can include, for example, 28 interconnects (e.g., a 4×7 array), 50 interconnects, 100 interconnects, 200 interconnects, 500 interconnects, 1000 interconnects, 2000 interconnects, or 5000 interconnects, including all values and sub-ranges in between. Fewer or more first interconnects are also possible. Generally, the number and/or layout of the interconnects 107 can be based on the number of cables to be connected, the size of the cables, etc. Forming the interconnects 107 in such an array-like layout condenses the spatial spread of the cables relative to conventional collector plates, which typically include a linear cable layout and hence need to be far wider than the cartridge 100 for the same (N×M) number of electrical cables. For example, a center-to-center separation between adjacent interconnects can be from about 0.1 inch, 0.5 inch, 1 inch, 1.5 inches, 2 inches, or greater than 2 inches, including all values and sub-ranges in between. In some cases, the center-to-center separation can be as low as permitted by factors such as clearance required for connecting the cables, shielding thickness for supporting return currents in the cables, and/or the like. In some cases, an even higher density of layout of the interconnects 107 can be used such as, for example, a staggered hold pattern/layout with a predetermined offset (e.g., 60 degrees).

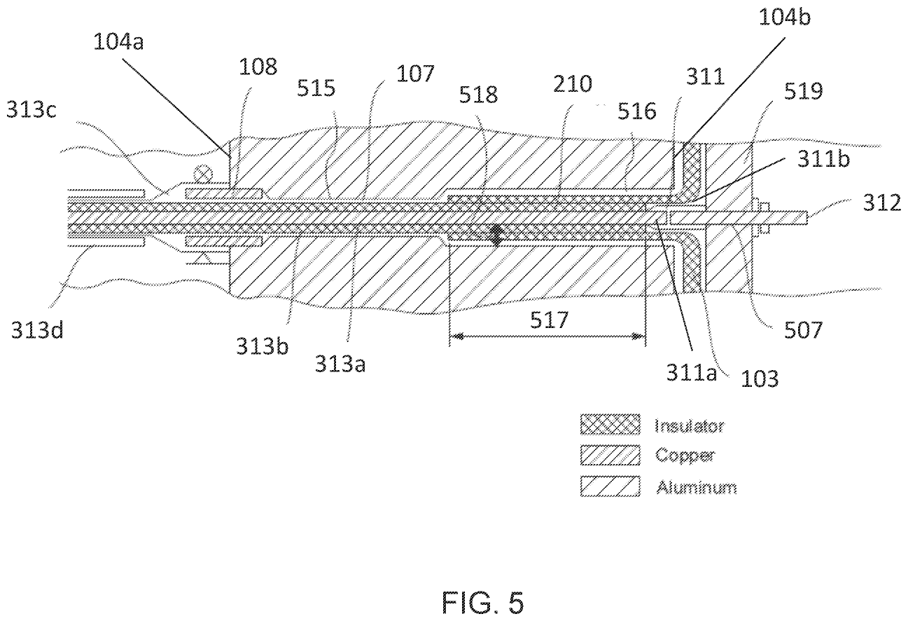

Each interconnect 107 can include and/or be aligned with a corresponding contact element 108 disposed on the first surface 104a of the insert block 102. Each contact elements 108 can be composed of any suitable conductive material (e.g., copper) and can be employed to electrically couple to a conductor of its corresponding cable (sometimes also referred to as a “first conductor”) such as, the shielding/ground of a cable 313 to the interconnect 107, one wire of a twisted pair cable (not shown), and/or the like. In some cases, the cable 313 can include any cable per the Radio Guide (RG) specification, or combinations thereof. For example, the cable 313 can be a hybrid of RG 213 and RG 217, with a 10 American wire gauge (AWG) solid core and double shielded. The contact element 108 can then be sized to match the cable 313. As illustrated in FIGS. 3 and 5, the cable 313 can be stripped before insertion into the interconnect 107, though the end of the cable and the interconnect 107 may be collectively configured for any suitable connection mechanism to ensure electrical connectivity and reduced impedance at the connection, which in turn leads to reduced reflection at the connection. The electrical coupling between the (for example) shield layer 313c and the contact element 108 can be formed in any suitable manner such as, for example, via a screw terminal.

Referring to FIGS. 3 and 5, within each first interconnect 107 and its corresponding second interconnect 210, a conductive connector 311 (also sometimes referred to as an “end”, “end piece”, and/or the like) is at least partially disposed as illustrated. Generally, such a connector can be employed to couple a current-carrying conductor of the cable 313 to the back plate 519 and can include, but is not limited to, butt connectors, spade connectors, plug and socket connectors, blade connectors, ring terminals, fork terminals, binding posts, collets, combinations thereof, and/or the like. In some cases, the connector is optional, and the conductor of the cable 313 can be directly coupled to the back plate 519 such as via crimping, soldering, brazing, welding, combinations thereof, and/or the like.

Returning to the example connector 311 illustrated in FIGS. 3 and 5, the connector 311 can be electrically coupled to its corresponding conductor 313a (or more generally a conductor of the cable, sometimes also referred to as a “second conductor”) at a first end 311a of the connector, when the cable 313 is inserted into the interconnect 107 via the opening defined by the contact element 108 of that interconnect 107. The connectors 311 can be composed of brass (i.e., is sometimes referred to as a “brass end”) and/or any other suitable electrical conductor that can be formed in any suitable manner (e.g., machined, molded, extruded, and/or the like). Each connector 311 can include a hole (e.g., in some cases, a threaded hole) at its first end 311a that receives the conductor 313a of the cable 313 for electrical and mechanical coupling such as via, for example, soldering or brazing. Each connector 311 can also include another hole at its second end 311b that is coupled to a threaded rod 312 (e.g., a steel rod) such as via, for example, welding, that in turn is used to secure and electrically connect the connector 311 to a back plate 519 (see FIG. 5, sometimes also referred to as a “high voltage (HV) plate”). The conductor 313a can be composed of any suitable conductor including, but not limited to, aluminum, copper, steel, and/or the like. In this manner, the threaded rod is disposed at least in part in a third interconnect 507 (explained below) of the back plate 519.

This arrangement has lower inductance relative to conventional wire-over-plane arrangements. Without being limited by any theory in particular, by using the connector 311 and the cable 313, there is little or no volume between the current carrier and the current return (as is the case in conventional wire-over-plane arrangements) that can potentially be filled with magnetic field. Such a small volume, if any, does not add significantly or meaningfully to the inductance of the connection established with the cable 313. Further, the use of the connector 311 for coupling the cable 313 to the back plate 519 can also result in flux exclusion, particularly for pulsed electrical currents.

As illustrated in FIG. 5, each interconnect 107 can include a narrow portion 515 and a broad portion 516, with the narrow portion 515a being useful for excluding flux and lowing the inductance associated with the cable conductor 313a by bringing the current return path physically closer to the conductor 313a. As a result, magnetic forces on the conductor 313a are substantially balanced, which is particularly desirable for high current applications. For example, the approximate diameter of the narrowed portion 515 can be about the same as an insulator layer 313b (see FIG. 5) of the cable 313. As a result, this reduces any flux that may inhabit the interstitial space between the cable 313 and the body portion 105 (e.g., when the body portion 105 is made of a conductor, such as aluminum or any other suitable material). As this design brings the body portion 105 closer to the conductor 313a, it ultimately reduces the inductance of the interconnect 107.

Generally, a cross sectional area and/or diameter of the broad portion 516 can be greater than a cross-sectional area and/or diameter of the narrow portion 515. For example, in some cases, the cross-sectional diameter of the narrow portion 515 can be substantially equal to a cross-sectional diameter of a coaxial cable 313 (or, as an alternative, one conductor of a twisted pair) disposed in that first interconnect with its shield layer 313c removed. As another example, in some cases, the cross-sectional diameter of the broad portion 516 is substantially equal to or greater than a cross sectional diameter of the intruding portions of the insulator block 103.

FIGS. 3, 5 illustrate detail for an example cable 313 that is inserted through the interconnects of the insert block 102 and the insulator block 103. The outer jacket 313d and the shield layer 313c of the cable 313 are stripped for the portion of the cable that is inserted into the insert block 102 and the insulator block 103. A portion of the shield layer 313c protrudes beyond the jacket 313d for coupling to the contact element 108 (see FIG. 5). The insulator/dielectric layer 313b is maintained for a portion of the cable 313 that is and is stripped at its distal end to expose the center conductor 313a. The conductor 313a is in turn coupled to the connector 311, which (at its other end) is coupled to a rod that is at least partially disposed within the insulator block 103 after assembly (see FIG. 5). The cable setup illustrated in FIG. 3 can be generated and preassembled before inserting the cable 313 into the insert block 102 and the insulator block 103. To generate the cable setup of FIG. 3, a portion of the jacket 313d can be removed to generate a first exposed portion 314a of that cable, such that the shield layer 313c is exposed. Then, a portion of the shield layer 313c is removed to generate a second exposed portion 314b, such that the insulating layer 313b is exposed. As described in greater detail later, a portion of the shield layer 313c can be coupled to the contact element 108 for establishing a return path for electrical current. Then, a portion of the insulating layer 313b is removed to generate a third exposed portion 314,c which includes the conductor 313a, for purposes of coupling the conductor 313a to the plate 519. For iterations involving other cables, such as a twisted wire, a similar approach can be taken with one of the two conductors, except there will no need to remove the shield layer or outer jacket.

Impedance matching at the connection of the cable 313 is also achieved by this arrangement due to the gradual change in impedance from the cable 313, through the connector 311, and to the back plate 519. Reflections at the interconnection, which can lead to electrical and/or radio noise, energy loss, and/or voltage transients, are reduced and/or otherwise mitigated by the cartridge apparatus 101 compared to conventional approaches. Such reflections, often seen in conventional wire-over-plane approaches, can ultimately lead to electrical faults and failures, and can require additional mitigating circuitry, such as, for example, snubbers that result in further circuit complexity and energy loss.

Additionally, such an interconnection of the cable 313 (i.e., as established by the connector 311 and the back plate 519) experienced significantly reduced or no Laplace force, since the magnetic forces on the core conductor of the cable 313 are balanced about its central axis (i.e., axisymmetric), such that it experiences no net force. In contrast, when a cable interfaces with a conventional collector plate, the end connector returns current asymmetrically and results in a net Laplace force on the cable. More specifically, the conductor 313a is substantially, fully surrounded by the electrically conductive material of the body portion 105 once the cable 313 is placed in the interconnect 107. As a result, there is no net Laplace force on the conductor 313a. In contrast, with a conventional collector plate, the coaxial shield of the cable 313 is stripped back to create a long section of center conductor that does not have a return conductor on all sides; instead a return conductor is formed on one side to carry current back to the shield. This side-by-side current conductor design creates a net Laplace force on the center conductor. The Laplace force on a conductor can lead to deformation and long-term damage, especially in conductors carrying high current and/or pulsed/repetitive electrical currents.

Further, several aspects of the cartridge apparatus 101 are useful for isolating and/or insulating the electrical current/voltages in different cables 313 from each other, especially when the cables 313 are at different electrical potentials. For example, different capacitor banks operating at different frequencies and/or voltages can be attached to the same cartridge apparatus 101 via different cables 313. Further, as described herein impedance matching between the connection of the cables 313, through the connector 311, and to the back plate 519 is improved for the entire range of electrical current/voltages of operation, which in turn results in improved efficiency. As another example, snubber and/or filter circuits can be attached to some of the connection points (e.g., to the coupled conductor 313a-threaded rod 312 setup), depending on the nature of the electrical voltage.

FIGS. 1, 2, and 4-6 illustrate the insulator block 103, which is coupled to the second surface 104b of the insert block 102 opposite to the first surface 104a, where the cables 313 are coupled to the apparatus 101. The coupling between the insulator block 103 and the insert block 102 can be achieved in any suitable manner such as, for example, by compressing the insulator block 103 between the insert block 102 and the back plate 519, by use of fasteners, crimping, soldering, and/or the like.

Generally, the insulator block 103 can be composed of any suitable electrically insulating material such as, for example, High Density Polyethylene (HDPE) having sufficiently high dielectric strength and low surface tracking.

The insulator block 103 can be employed to create an electrical insulation barrier between the insert block 102 and the back plate 519, which can be at different potentials sometimes. However, it is understood that the insulator block 103, the insert block 102, and the back plate 519 can each independently be set at ground, neutral, positive, or negative potential, in a static or an intermittent/time-varying manner (e.g., pulsed, oscillatory, and/or the like).

For example, in some use cases, the insert block 102, which is electrically coupled to the shield layers 313c of the cables 313 (or one wire of a twisted wire pair), can attain a negative or ground potential during use (e.g., continuously or intermittently), whereas the back plate 519, which is electrically coupled to the conductors 313a of the cables 313 (or the other wire of a twisted wire pair), can attain at a positive potential (e.g., continuously or intermittently, in sync with the changes to potential of the insert block 102 for example). Similar to the insert block 102, the insulator block 103 can include interconnects or passageways 210 (sometimes also referred to as “second interconnects”) that are aligned with/continuous with the corresponding interconnects 107. As illustrated in FIG. 5, portions of the insulator block 103 intrude into the broad portion 516 of the interconnects 107 such that each of the second interconnects 210 is disposed at least in part within the broad portion 516 of its corresponding first interconnect 107. The combination of the insulator 313b on the cable and the portions of the insulator block 103 within the interconnect permit the delivery of higher voltages.

FIG. 5 also illustrates how the threaded rod 312 is attached to the back plate 519 using a washer. In this manner, the back plate 519 serves as a collection plate that is electrically coupled to the center conductors 313a of all the cables 313. The back plate 519 can be composed of any suitable conducting material such as, for example, aluminum. Similar to the insert block 102 and the insulator block 103, the back plate 519 can include interconnects or passageways 507 (sometimes also referred to as “third interconnects”) that are aligned with/continuous with the corresponding first interconnects 107 and second interconnects 210. As explained in greater detail herein, each of the cables 313 is then disposable through one of the first interconnects 107, its corresponding second interconnect 210, and its corresponding third interconnect 507 such that a second conductor of that cable (e.g., a center conductor of a coaxial cable) is electrically insulated from the insert block 102 and is electrically coupled to the back plate 519.

FIG. 5 also illustrates an axial standoff distance 517 (also sometimes referred to as a “tracking distance” or a “surface tracking distance”) that can be characterized as the extent, degree, or length of overlap between a portion of an insulation (e.g., the insulation layer 313b) of the cable 313 disposed in that first interconnect 107 with the portion of the insulator block 103 that intrudes into that first interconnect 107. The standoff distance 517 generally represents how the clearance fit between the intruding portions of the block 103 and the insulator layer 313b results in the standoff distance 517 between the block 102 and the back plate 519. The greater the magnitude of the standoff distance 517 (i.e., of the overlap between the block 103 and the insulator layer 313b), the greater the resilience to dielectric breakdown that can occur due to tracking of the electrical current from the conductor 313a along the gap between the block 103 and the insulator layer 313b, and the greater the voltage that can be applied/delivered to the plate 519. In some cases, the axial standoff distance can be about 0.5 inch, about 1 inch, about 2 inches, about 4 inches, about 6 inches, about 8 inches, about 10 inches, about 12 inches, about 15 inches, or the entire length of the insert block, including all values and sub-ranges in between. FIG. 5 also illustrates the linear distance 518 between the conductor 313a and the block 102, and represents the linear separation between these elements. The dielectric properties of the insulator block 103 and the insulator layer 313b, as well as the thickness of each of these along the linear distance 518, can factor into the resilience of this setup to electrical breakdown along the linear distance 518.

In some aspects, the systems and apparatuses described herein can include any suitable mechanism for holding the various components (e.g., the insert block 102, the insulator block 103, and the back plate 519) compressively and/or forcibly in place with respect to each other and/or for coupling the system/apparatus to other components (e.g., a magnetic coil, a feed plate, etc.). The mechanism may comprise, but not be limited to, one or more side plates, clamps, bolts (conducting or dielectric/insulating), nails, clips, latches, rivets, combinations thereof. Without being limited by any theory in particular, a return current being delivered to the cables 313 via the insert block 102 will tend to mechanically move the insert block in relation to the rest of the apparatus 101, and in turn could lead to stress and/or fracturing of the cables disposed within the apparatus 101. Holding mechanisms as described herein can prevent such failure.

As an example of such a holding mechanism, FIG. 6 illustrate a side view of an example setup/system 600, assembled and during use, with coaxial cables 313 attached. FIG. 6 also illustrates a side plate 623 that engages and/or is otherwise mechanically coupled to the block 102 (e.g., via fasteners that engage the receptacles 106) and the back plate 519, such that the insulator block 103 is held in a compressively coupled manner against the block 102 and the back plate 519. The holding mechanism (here, the side plate 623) can be formed of any suitable dielectric material such as, for example, a fiberglass laminate (e.g., G-10). The setup 600 can include an identical side plate and/or another holding mechanism disposed on the opposite side as well (not shown).

The apparatus 601 in FIG. 6 can engage a much greater or lesser number of the cables 313 than that illustrated in FIGS. 1-2 and 4, which in turn can be used to deliver greater voltages, and illustrates the scalability of the cartridge design. Generally, for any given end use, compared to conventional approaches, the apparatus 601 instead permits greater current to be delivered through each cable even when keeping the number of cables constant, and increasing the number of cables can be employed to deliver greater voltages.

In some cases, the setup 600 can additionally or alternatively be part of a larger setup or system such as, for example, a system for plasma research/development or medical isotope generation. The design of such setups (e.g., shape of various components, layout of the components, etc.) can be based on, for example, simulated current density studies to avoid current crowding and reduce stray inductance. Ohmic heating generally scales with I²*R, so current crowding can be dangerous due to high current I and/or high resistance R, and can further lead to mechanical failures in high current applications.

The setup 600 includes the cartridge apparatus 601 (including the back plate 519), a first feed plate 620, and a second feed plate 621, though it is understood that additional plates can be employed depending on the shape and/or layout of a particular setup. The plates 620, 621 can be composed of any suitable conducting material such as, for example, aluminum. The first feed plate 620 is electrically coupled to the back plate 519 at one end, and can couple to any load/electrical component such as, for example, a magnetic coil 622 as illustrated herein, at the other end to deliver the electrical current from the cables 313 to the coil 622 via a positive terminal of the coil 622. The coupling between the back plate 519 and the feed plate 620 can be performed in any suitable manner than reduces or minimizes electrical resistance and increases or maximizes contact pressure between the plates. For example, in some cases (not shown) features such as lap connections (to increase the surface area and clamping force between these components) and/or flux gaps (to direct current flow, and in turn further reduce impedance and prevent short cutting, which can otherwise lead to poor connection and arcing) can be employed.

For the return path, the coil 622 (e.g., a negative terminal of the coil 622) can be electrically coupled to the second feed plate 621, which in turn is electrically coupled to the insert block 102, to establish a return path for the electrical current via the contact elements 108 of the block 102. The coupling between the second feed plate 621 and the bridge plate 624 can be made in substantially the same manner as for the plates 519, 620, and in some cases (not shown), can employ a lap connection and/or a flux gap. The coupling between the second feed plate 621 and the insert block 102 can be made proximate to the contact elements 108, which can reduce or minimize stray inductance within the body 105 of the insert block 102. Generally, it is understood that, depending on the shape and layout of the components selected for a particular setup, there may be additional plates between the first feed plate 620 and the back plate 519, between the second feed plate 621 and the insert block 102, between the first feed plate 620 and the coil 622, and/or between the second feed plate 621 and the coil 622.

The current flow through the setup 600 can generally be as follows. The insert block 102, being electrically coupled to the shield layers 313c of the cables 313, is held at a negative or ground potential. Electrical current is delivered through the center conductors 313a to the back plate 519, and coupled to the coil 622 via the plate 620. The return current from the coil 622 is coupled into the plate 621, and in turn to the insert block 102. Current flow within the insert block is through the shielding layers 313c via the contact elements 108.

While FIG. 6 illustrates the use of the feed plates 620, 621 for current delivery and return, it is understood that use of one or both of these plates can be optional. Said another way, in some cases, the insert block 102 can be directly, electrically coupled to the wiring of the coil 622 without any intervening electrical components, and/or the back plate 519 can be directly, electrically coupled to coil 622 without any intervening electrical components. In other cases, other electrical components (in addition to or alternative to the illustrated feed plates) can be employed for current delivery and/or return.

In some cases, one or more components (e.g., the insert block 102 and/or the back plate 519) of any of the cartridge apparatuses described herein can include one or more passageways/vias formed or drilled through their volume for circulating a cooling fluid such as water, ethylene glycol, polyethylene glycol, combinations thereof, and/or the like. The cooling fluid can be circulated via tubing disposed within the via(s), or directly injected and removed from the vias, such as using fluid-tight connections to the via(s). Each component can have its own cooling setup, or a single cooling setup can encompass multiple components such as, for example a single tubing running through a via in the insert block as well as a via of the back plate. With the insert block 102 as a representative example, the cooling passageways/vias can be formed in any suitable manner including, but not limited to, parallel to the interconnects 120 (e.g., interspersed with the interconnects, disposed on an outer perimeter of the interconnects, combinations thereof), perpendicular to the interconnects (i.e., running from a side of the insert block 102 to an opposing side), and/or the like.

In some cases, some of the interconnects formed through the insert block, insulator block, and back plate can be used to circulate a cooling fluid as described herein. Any suitable selection regarding which interconnects are used with the cables 313 and which are used for cooling are within the scope of the embodiments disclosed herein. In such cases, the need for separate cooling interconnects is obviated and dynamic utilization of the interconnects 120 for either electrical connectivity or cooling fluid delivery is possible. Additionally or alternatively, in some cases, one or more of the cables 313 coupled to the apparatus can be a fluid-cooled cable. For example each such fluid cooled cable can include an outermost rubber hose/layer for containing water or another coolant in a fluid tight manner, such as by securing the rubber hose at both ends of the cable using steel bands.

In some cases, the coolant can include a dielectric material (such as an oil) that can either be circulated as described herein, or (additionally or alternatively) the apparatus as a whole can be submerged in the coolant after assembly, such that seepage of the coolant into the interconnects 120 and/or separately formed cooling interconnects can permit for cooling of the apparatus. Aspects of the cooling approaches disclosed herein can be particularly beneficial for using the apparatus in high power and/or high repetition rate applications, where there may be significant heat generated by the currents running through the insert block and/or the back plate.

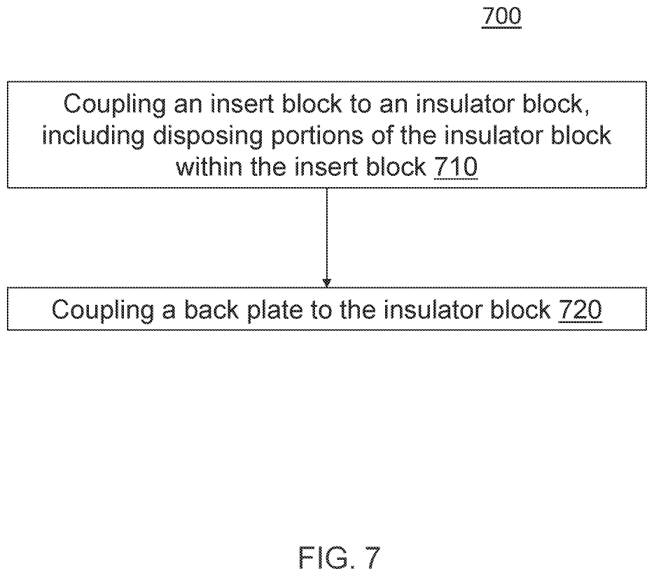

FIG. 7 illustrates an example method 700 for assembling an apparatus for coupling a set of cables to an electrical component such as, for example, the apparatus 101 and/or 601 and/or a structurally and/or functionally similar variant thereof. In some cases, the electrical component can be a magnetic coil.

Explained with reference to the apparatus 101 or 601, at step 710, the method 700 includes coupling an insert block (e.g., the insert block 102) to an insulator block (e.g., the insulator block 700). The insert block is electrically conductive and the insulator block is electrically insulating. The insert block defines a first surface (e.g., the surface 104a), a second surface (e.g., the surface 104b) and a volume therebetween such that the insulator block is coupled to the insert block at the second surface. The insert block includes a set of contact elements (e.g., the contact elements 108) disposed on the first surface to electrically couple to a set of first conductors (e.g., the shield layers 313c) of the set of cables (e.g., the cables 313). The insert block also includes a set of first interconnects (e.g., the interconnects 107) arranged as an array through the volume of the insert block, with each first interconnect including a passage formed through the volume of the insert block.

As also illustrated for step 710, the coupling can include including disposing portions of the insulator block within the insert block (e.g., see FIG. 5) such that each second interconnect (e.g., the interconnects 210) of the insulator block is at least partially disposed within a broad portion (e.g., the portion 516) of a corresponding first interconnect.

At step 720, the method 700 further includes coupling a back plate (e.g., the plate 519) to the insulator block, where the back plate is electrically conductive. In this manner, each third interconnect (e.g., the interconnect 507) of the back plate is coaxial with and/or aligned with a corresponding second interconnect of the insulator block. During use then, a set of cables are disposable through the first interconnects, the second interconnects, and the third interconnects such that, for each cable, a second conductor (e.g., the center conductor 313a) of that cable is electrically isolatable from the insert block and is electrically couplable to the back plate.

In some cases, the method 700 further includes coupling a first feed plate (e.g., the plate 620) to the back plate, and then coupling the first feed plate to the electrical component (e.g., the coil 622) to permit for delivery of electrical current from the cables to the electrical component during use. In some cases, the method 700 further includes coupling a second feed plate (e.g., the plate 621) to the electrical component to establish a return path for a return current from the electrical component, and coupling the second feed plate to the insert block to permit the return current to return through the set of contact elements. In some cases, the method 700 further includes directly, electrically coupling the apparatus to the electrical component (e.g., directly coupling the insert block and the back plate to the coil 622) without any intervening components.

In some cases, the method 700 further includes coupling the cables to the apparatus by disposing the cables through the set of first interconnects, the set of second interconnects, and the set of third interconnects such that, for each cable, a second conductor of that cable is electrically insulated from the insert block. The method 700 can further include coupling the second conductor of each cable (such as coaxial cable or twisted pair) to the back plate such as, for example, via use of the connector 311 and the rod 312 illustrated in FIG. 5.

In some cases, the cables are coaxial cables, and the method 700 can further include coupling the set of coaxial cables to the apparatus by (for each cable) removing, from an end of that coaxial cable, a portion of an outer jacket (e.g., the jacket 313d) of that coaxial cable along its length to generate a first exposed portion (e.g., the portion 314a) of that coaxial cable. The method 700 can further include removing, from the first exposed portion, a portion of a shield layer (e.g., the layer 313c) of that coaxial cable to generate a second exposed portion (e.g., the portion 314b) of that coaxial cable. The method 700 can further include removing, from the second exposed portion, a portion of an insulating layer (e.g., the layer 313b) of that coaxial cable to generate a third exposed portion (e.g., the portion 314c) of that coaxial cable, the third exposed portion including a center conductor (e.g., the conductor 313a) of that coaxial cable as the second conductor.

In some cases, the method 700 can further include coupling the center conductor of that coaxial cable into a first end of a connector (e.g., the end 311a of the connector 311), and coupling a second end (e.g., the end 311b) of the connector to a rod (e.g., the rod 312). The method 700 can further include inserting the coaxial cable into the apparatus via a selected first interconnect, its corresponding second interconnect, and its corresponding third interconnect, such that the connector abuts against the back plate and the rod protrudes beyond the back plate (see. FIG. 5). The method 700 can further include coupling a remainder portion of the shield layer (see FIG. 3) of that coaxial cable to a corresponding contact element of the insert block as the first conductor. The method 700 can further include securing the rod against the back plate.

In other cases, after generating the third exposed portion, the method 700 can further include inserting the coaxial cable into the apparatus via a selected first interconnect and it's corresponding second interconnect. The method 700 can then further include coupling the center conductor of that coaxial cable into the first end of the connector, and coupling the second end of the connector to the rod. The method 700 can further include securing the rod against the back plate via a selected third interconnect that corresponds to the first and second interconnects, and coupling a remainder portion of the shield layer of that coaxial cable to a corresponding contact element of the insert block.

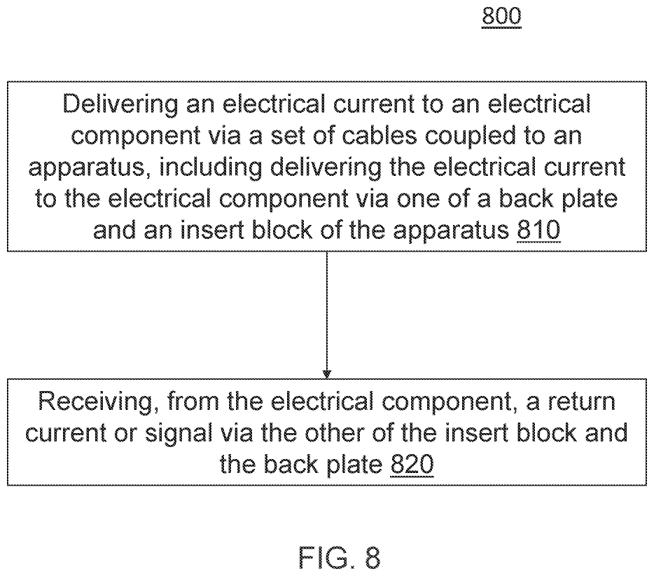

FIG. 8 illustrates a method 800 of circulating electrical current to an electrical component via a set of cables (e.g., the cables 313) coupled to an apparatus such as, for example, the apparatus 101 and/or 601 and/or a structurally and/or functionally similar variant thereof. In some cases, the electrical component can be a magnetic coil.

Explained with reference to the apparatus 101 or 601, at step 810, the method includes delivering the electrical current to the set of cables coupled to the apparatus. The apparatus includes an insert block (e.g., the block 102) defining a first surface (e.g., the surface 104a), a second surface (e.g., the surface 104b), and a volume therebetween, the insert block being electrically conductive and electrically coupled to the electrical component (e.g., the coil 622). The insert block includes a set of contact elements (e.g. the contact elements 108) disposed on the first surface that are electrically coupled to a set of first conductors (e.g., the shield layers 313c) of the set of cables. The insert block also includes a set of first interconnects (e.g., the interconnects 107) arranged as an array through the volume of the insert block, each first interconnect including a passage formed through the volume of the insert block. The apparatus further includes an insulator block (e.g., the block 103) that is electrically insulating and is coupled to the insert block. The insulator block includes a set of second interconnects (e.g., the interconnects 210) to align with the set of first interconnects, the insulator block being electrically insulating. The apparatus further includes a back plate that is electrically conductive and in turn includes a set of third interconnects (e.g., the interconnects 507) aligned with the set of first interconnects and the set of second interconnects. The set of cables are disposed through the set of first interconnects, the set of second interconnects, and the set of third interconnects such that, for each cable, a second conductor (e.g., the conductor 313a) of that cable is electrically insulated from the insert block and is electrically coupled to the back plate.

As illustrated in FIG. 8, the delivering at step 810 can further include delivering the electrical current to the electrical component via one of the back plate and the insert block. Said another way, while the apparatuses described herein (e.g., the apparatuses 101, 601, etc.) is described herein as useful for establishing current delivery via the back plate and current return via the insert block (see FIG. 6), it is understood that the reverse can be employed as well, i.e., current delivery can be via the insert block with current return via the back plate. Accordingly, the method 800 further includes receiving, from the electrical component, a return current via the other of the insert block and the back plate at step 820.

In some cases, step 810 further includes delivering the electrical current via a feed plate (e.g., one of the feed plate 620 and the feed plate 621) electrically coupled to the electrical component. In some cases, step 820 further includes receiving the return current further comprising receiving the return current via a feed plate electrically coupled to the electrical component.

In some cases, the method 800 further includes maintaining, continuously or intermittently, the insert block at a negative or ground potential and also maintaining, continuously or intermittently, the back plate at a positive potential.

Aspects herein are also directed to a kit that can be useful for delivery of electrical current to an electrical component, such as a magnetic coil. The components of the kit can be assembled as generally described for FIG. 7 herein. The kit can include a set of cables (e.g., the cables 313) for coupling to an electrical source such as, for example, coaxial cables, triaxial cables, twisted pair cables, and/or the like. In some cases, the cables can include at least two conductors, one for current delivery and another for current return. In other cases, the cables can include a single conductor, such that two cables can be used, one for current delivery and another for current return. The kit can also include an insert block (e.g., the block 102) that is electrically conductive and defines a first surface, a second surface, and a volume therebetween. The insert block can include a set of contact elements disposed on the first surface that can electrically couple to (e.g., for cables with at least two conductors) first conductors of the cables upon assembly. The insert block can also include first interconnects arranged as an array through the volume of the insert block, with each first interconnect including a passage formed through the volume of the insert block.

The kit can also include an insulator block that is electrically insulating and couplable to the insert block at the second surface upon assembly. The insulator block can include a set of second interconnects that can be aligned to the set of first interconnects. The kit can further include a back plate that is electrically conductive and couple able to the insulator block upon assembly. The back plate can include a set of third interconnects that can be aligned to the set of first interconnects and the set of second interconnects. In some cases, the number of cables of the kit can correspond to the number of contact elements of the insert block. In other cases, more or less cables can be included in the kit. In other cases, the cables can be optional and not included in the kit. In some cases, the cables can be provided in the form illustrated in FIG. 3, i.e., with one conductor of each cable being coupled to a connector, and the connector in turn being coupled to a rod. In other cases, the kit can include a set of connectors and a set of rods separate from the set of cables, with each corresponding in number to the number of cables. In some cases, the kit can further include a set of bolts and/or other fastening mechanisms for, upon assembly, securing the rods against the back plate.

Cables Useful with the Cartridge Apparatus

The apparatus 101 can be useful for current delivery with any kind of cables such as, but not limited to, twisted pair cables, coaxial cables, triaxial cables, quadrax cables, twinax cables, shielded cables, combinations thereof, and/or the like. In some cases, any cable that provides for at least one conductor for current delivery and another conductor for current return can be employed. Alternatively, one cable can be employed for current delivery (i.e., be electrically coupled to the back plate 519) through the interconnect, while another can be employed for current return (i.e., be electrically coupled to the contact element 108). In such cases, each cable need only have one conductor, though each cable may nevertheless have more than one conductor. In some cases, the cables include twisted pair cables that can be one or more of the following types, per the ISO/IEC (International Organization for Standardization/International Electrotechnical Commission) 11801 standard—U/UTP, F/UTP, S/UTP, SF/UTP, U/FTP, F/FTP, S/FTP, SF/FTP, combinations thereof, and/or the like. For example, one of the wires/cable of a twisted pair cable can be electrically coupled to a contact element 108 as the first conductor, and a second wire/cable of that twisted pair cable can be disposed through the apparatus and electrically coupled to the back plate 519 as the second conductor. As another example, one of the shield layers of a triaxial cable can be electrically coupled to a contact element 108 as the first conductor, and either the other shield layer or a center conductor of that triaxial cable can be disposed through the apparatus and electrically coupled to the back plate 519 as the second conductor. Generally, any of the three conductors of a triaxial cable (two shield layers and the center conductor) can be employed as the first conductor, and any of the remaining conductors can be employed as the second conductor. In some cases, two or more conductors of the triaxial cable can be combined into a single conductor prior to coupling to the apparatus 101. In some cases, one of the conductors of the triaxial cable can be hard grounded, which can permit for a greater voltage swing, from positive voltages to negative voltages, being applied to the electrical component.

In some cases, the cables include coaxial cables that can be one or more of the following types, per US specifications—RG6, RG7, RG8, RG9, RG11, RG56, RG58, RG59, 3C-2V, 5C-2V, RG-60, RG-62, RG-63, RG-142, RG-174, RG-178, RG-179, RG-180, RG-188, RG-195, RG-213, RG-214, RG-218, RG-223, RG-316, RG-400, RG-402, RG-405, H155, H500, LMR-100, LMR-195, LMR-200, HDF-200, CFD-200, LMR-240, EMR-240, LMR-300, LMR-400, HDF-400, CFD-400, EMR-400, LMR-500, LMR-600, LMR-900, LMR-1200, LMR-1700, LDF4-40A, LDF5-50A, QR-320, WR-540, QR-715, QR-860, QR-1125, combinations thereof, and/or the like.

In some cases, the cables include power cables typically used for delivery of electricity for residential or commercial consumption, and can be one or more of the following types—service drop cables (including duplex, triplex, and quadruplex cables), panel feed cables, non-metallic sheathed cables (including two wire cables and three wire cables), metallic sheathed cables, direct-buried cables, armored cables, metal clad cables, multi-conductor cables, paired cables, ribbon cables, shielded cables, single stranded wire cables, single solid wire cables, submersible cables, ladder line cables, twin-lead cables, underground feeder cables, flexible cables, stranding in layer cables, stranding in bundle cables, overhead power line cables, all aluminum conductor (AAC) cables, all aluminum alloy conductor (AAC) cables, aluminum conductor steel-reinforced (ACSR) cables, aluminum conductor aluminum-alloy reinforced (ACAR) cables, bundled conductor cables, combinations thereof, and/or the like. Generally, any cable can be employed that can be segmented or arranged such that the portion of a cable, such as a first conductor(s) of the cable, conducting to the back plate of the cartridge is electrically isolated from another portion of a cable, such as a second conductor(s) of the cable, returning current from the insert block. This can be accomplished, for example, by arrangement of cables in a twisted pair format.

Accordingly, while various embodiments are explained herein with respect to coaxial cables for ease of explanation, it is understood that any suitable cable design can be employed based on factors such as availability, application, desirable cable specifications, and/or the like.

### CONCLUSION

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. The foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for coupling a set of cables to an electrical component, comprising:
an insert block defining a first surface and a second surface and a volume therebetween, the insert block being electrically conductive, the insert block including:
a set of contact elements disposed on the first surface to electrically couple to a set of first conductors of the set of cables; and
a set of first interconnects arranged as an array through the volume of the insert block, each first interconnect including a passage formed through the volume of the insert block;
an insulator block coupled to the insert block at the second surface and including a set of second interconnects aligned to the set of first interconnects, the insulator block being electrically insulating; and
a back plate coupled to the insulator block and including a set of third interconnects aligned to the set of first interconnects and the set of second interconnects, the back plate being electrically conductive,
wherein a set of second conductors of the set of cables are disposable through the set of first interconnects, the set of second interconnects, and the set of third interconnects such that the set of second conductors are electrically insulated from the insert block and are electrically coupled to the back plate.

2. The apparatus of claim 1, wherein the insert block is configured to be maintained at a negative or ground potential during use, and wherein the back plate is configured to attain, either continuously, in an intermittent manner, or both, a positive potential during use.

3. The apparatus of claim 1, wherein each first interconnect of the set of first interconnects includes a narrow portion and a broad portion having a cross-sectional area greater than a cross-sectional area of the narrow portion, wherein a portion of the insulator block intrudes into the broad portion of each first interconnect of the set of first interconnects, such that each second interconnect of the set of second interconnects is disposed at least in part within the broad portion of its corresponding first interconnect.

4. The apparatus of claim 1, wherein the electrical component is a magnetic coil.

5. The apparatus of claim 1, further comprising a side plate mechanically coupled to the insert block and the back plate to maintain the apparatus in place.

6. The apparatus of claim 5, wherein the side plate is composed of a dielectric material.

7. The apparatus of claim 1, wherein a center-to-center separation between adjacent interconnects of the set of first interconnects is at most from about 0.1 to about 2 inches.

8. The apparatus of claim 1, further comprising a set of connectors, each connector of the set of connectors at least partially disposed within a corresponding second interconnect of the set of second interconnects, wherein during use each connector of the set of connectors is electrically coupled to a second conductor of a corresponding cable disposed in that second interconnect at a first end of that connector and is electrically and mechanically coupled to the back plate at a second end of that connector.

9. The apparatus of claim 8, wherein the second end of that connector is coupled to a corresponding rod that is electrically coupled to back plate, wherein the rod is disposed in a corresponding third interconnect of the set of third interconnects of the back plate.

10. The apparatus of claim 1, wherein each first interconnect of the set of first interconnects includes a narrow portion and a broad portion having a cross-sectional diameter greater than a cross-sectional diameter of the narrow portion, and wherein the cross sectional diameter of the narrow portion is substantially equal to a cross-sectional diameter of the cable disposed in that first interconnect.

11. The apparatus of claim 1, wherein, within a given first interconnect of the set of first interconnects, a portion of an insulation of the cable disposed in that first interconnect overlaps with a portion of the insulator block intruding into that first interconnect to define an axial standoff distance.

12. The apparatus of claim 11, wherein the axial standoff distance is from about 1 inch to about 12 inches.

13. The apparatus of claim 1, wherein the set of cables includes a set of twisted pair cables, wherein a first cable of each twisted pair cable is electrically coupled to a corresponding contact element of the set of contact elements as the first conductor, and wherein a second cable of that twisted pair cable is electrically coupled to the back plate as the second conductor.

14. The apparatus of claim 1, wherein the set of cables includes a set of coaxial cables, wherein a shield layer of each coaxial cable is electrically coupled to a corresponding contact element of the set of contact elements as the first conductor, and wherein a center conductor of that coaxial cable is electrically coupled to the back plate as the second conductor.

15. The apparatus of claim 1, wherein the set of cables includes a set of triaxial cables, wherein a first shield layer and/or a second shield layer of each triaxial cable is electrically coupled to a corresponding contact element of the set of contact elements as the first conductor, and wherein a center conductor of that triaxial cable is electrically coupled to the back plate as the second conductor.

16. The apparatus of claim 1, wherein each first conductor of the set of first conductors is electrically coupled to its corresponding contact element of the set of contact elements via a screw terminal.

17. The apparatus of claim 1, wherein the insert block and the back plate are each directly, electrically coupled to the electrical component without any intervening components.

18. A system, comprising:
the apparatus of claim 1;
a first feed plate electrically coupled to the back plate, wherein the first feed plate is further electrically coupled to the electrical component to deliver electrical current from the set of coaxial cables to the electrical component;
a second feed plate electrically coupled to the electrical component to establish a return path for a return current from the electrical component, the second feed plate further electrically coupled to the insert block to permit the return current to return through the set of contact elements.

19. The system of claim 18, wherein the electrical component is a magnetic coil.

20. A method of assembling an apparatus for coupling a set of cables to an electrical component, comprising:
coupling an insert block to an insulator block, the insert block defining a first surface and a second surface and a volume therebetween such that the insulator block is coupled to the insert block at the second surface, the insulator block being electrically insulating, the insert block being electrically conductive and including:
a set of contact elements disposed on the first surface to electrically couple to a set of first conductors of the set of cables; and
a set of first interconnects arranged as an array through the volume of the insert block, each first interconnect including a passage formed through the volume of the insert block,
the coupling including disposing portions of the insulator block within the insert block such that each second interconnect of a set of second interconnects of the insulator block is at least partially disposed within a broad portion of a corresponding first interconnect of the set of first interconnects; and
coupling a back plate to the insulator block, the back plate being electrically conductive, such that each third interconnect of a set of third interconnects of the back plate is aligned with a corresponding second interconnect of the set of second interconnects of the insulator block, such that during use a set of second conductors of the set of cables are disposable through the set of first interconnects, the set of second interconnects, and the set of third interconnects and such that during use, the set of second conductors of the set of cables are electrically isolatable from the insert block and are electrically couplable to the back plate.

21. The method of claim 20, further comprising:
coupling a first feed plate to the back plate; and
coupling the first feed plate to the electrical component to permit for delivery of electrical current from the set of cables to the electrical component during use.

22. The method of claim 21, further comprising:
coupling a second feed plate to the electrical component to establish a return path for a return current from the electrical component; and
coupling the second feed plate to the insert block to permit the return current to return through the set of contact elements.

23. The method of claim 20, further comprising:
directly, electrically coupling the apparatus to the electrical component without any intervening components.

24. The method of claim 20, further comprising coupling the set of cables to the apparatus by disposing the set of cables through the set of first interconnects, the set of second interconnects, and the set of third interconnects such that, for each cable of the set of cables, a second conductor of that cable is electrically insulated from the insert block; and
coupling the center conductor of each cable to the back plate.

25. The method of claim 20, wherein the set of cables is a set of coaxial cables, further comprising coupling the set of coaxial cables to the apparatus by, for each coaxial cable of the set of coaxial cables:
removing, from an end of that coaxial cable, a portion of an outer jacket of that coaxial cable along its length to generate a first exposed portion of that coaxial cable;
removing, from the first exposed portion, a portion of a shield layer of that coaxial cable to generate a second exposed portion of that coaxial cable;
removing, from the second exposed portion, a portion of an insulating layer of that coaxial cable to generate a third exposed portion of that coaxial cable, the third exposed portion including a center conductor of that coaxial cable as the second conductor;
coupling the center conductor of that coaxial cable into a first end of a connector;
coupling a second end of the connector to a rod;
inserting the coaxial cable into the apparatus via a selected first interconnect, its corresponding second interconnect, and its corresponding third interconnect, such that the connector abuts against the back plate and the rod protrudes beyond the back plate;
coupling a remainder portion of the shield layer of that coaxial cable to a corresponding contact element of the insert block as the first conductor; and
securing the rod against the back plate.

26. The method of claim 20, wherein the set of cables is a set of coaxial cables, further comprising coupling the set of coaxial cables to the apparatus by, for each coaxial cable of the set of coaxial cables:
removing, from an end of that coaxial cable, a portion of an outer jacket of that coaxial cable along its length to generate a first exposed portion of that coaxial cable;
removing, from the first exposed portion, a portion of a shield layer of that coaxial cable to generate a second exposed portion of that coaxial cable;
removing, from the second exposed portion, a portion of an insulating layer of that coaxial cable to generate a third exposed portion of that coaxial cable, the third exposed portion including a center conductor of that coaxial cable as the second conductor;
inserting the coaxial cable into the apparatus via a selected first interconnect and its corresponding second interconnect,
coupling the center conductor of that coaxial cable into a first end of a connector;
coupling a second end of the connector to a rod;
securing the rod against the back plate via a selected third interconnect that corresponds to the first and second interconnects; and
coupling a remainder portion of the shield layer of that coaxial cable to a corresponding contact element of the insert block as the first conductor.

27. The method of claim 20, wherein the electrical component includes a magnetic coil.

28. A method of circulating electrical current to an electrical component via a set of cables coupled to an apparatus, the method comprising:
delivering the electrical current to the set of cables coupled to the apparatus, the apparatus including:
an insert block defining a first surface and a second surface and a volume therebetween, the insert block being electrically conductive and electrically coupled to the electrical component, the insert block including:
a set of contact elements disposed on the first surface that are electrically coupled to a set of first conductors of the set of cables; and
a set of first interconnects arranged as an array through the volume of the insert block, each first interconnect including a passage formed through the volume of the insert block;
an insulator block coupled to the insert block and including a set of second interconnects to align with the set of first interconnects, the insulator block being electrically insulating; and
a back plate including a set of third interconnects aligned with the set of first interconnects and the set of second interconnects, wherein the set of cables are disposed through the set of first interconnects, the set of second interconnects, and the set of third interconnects such that, for each cable of the set of cables, a second conductor of that cable is electrically insulated from the insert block and is electrically coupled to the back plate, the back plate being electrically conductive;
the delivering including delivering the electrical current to the electrical component via one of the back plate and the insert block; and
receiving, from the electrical component, a return current via the other of the insert block and the back plate.

29. The method of claim 28, the delivering the electrical current further comprising delivering the electrical current via a feed plate electrically coupled to the electrical component.

30. The method of claim 28, wherein the receiving the return current further comprising receiving the return current via a feed plate electrically coupled to the electrical component.

31. The method of claim 28, wherein the electrical component includes a magnetic coil.

32. The method of claim 28, further comprising:
maintaining, continuously or intermittently, the insert block at a negative or ground potential; and
maintaining, continuously or intermittently the back plate at a positive potential.

33. An apparatus for coupling a set of cables to an electrical component, comprising:
an insert block defining a first surface and a second surface and a volume therebetween, the insert block being electrically conductive, the insert block including:
a set of contact elements disposed on the first surface to electrically couple to a set of first conductors of the set of cables; and
a set of first interconnects arranged as an array through the volume of the insert block, each first interconnect including a passage formed through the volume of the insert block; and
an insulator block coupled to the insert block at the second surface and including a set of second interconnects aligned to the set of first interconnects, the insulator block being electrically insulating,
wherein a set of second conductors of the set of cables are disposable through the set of first interconnects and the set of second interconnects such that the set of second conductors are electrically insulated from the insert block.

34. A kit, comprising:
a set of cables, each cable of the set of cables including a first conductor and a second conductor;
an insert block defining a first surface and a second surface and a volume therebetween, the insert block being electrically conductive, the insert block including:
a set of contact elements disposed on the first surface to electrically couple to a set of first conductors of the set of cables; and
a set of first interconnects arranged as an array through the volume of the insert block, each first interconnect including a passage formed through the volume of the insert block;
an insulator block couplable to the insert block at the second surface and including a set of second interconnects that can be aligned to the set of first interconnects, the insulator block being electrically insulating; and
a back plate couple able to the insulator block and including a set of third interconnects that can be aligned to the set of first interconnects and the set of second interconnects, the back plate being electrically conductive,
wherein a set of second conductors of the set of cables are disposable through the set of first interconnects, the set of second interconnects, and the set of third interconnects such that the set of second conductors can be electrically insulated from the insert block and can be electrically coupled to the back plate.
